(19) United States
(12) Patent Application Publication
(10) Pub. No.: US 2018/0017460 A1
(43) Pub. Date: Jan. 18, 2018

(54) A SYSTEM AND METHOD FOR CALLIBRATING AND CONTROLLING PRESSURE

(71) Applicant: SETRA SYSTEMS, INC., Boxborough, MA (US)

(72) Inventors: Anthony T. BATISTA, Milford, MA (US); Shawn Oscar HENRY, Pepperell, MA (US); Joshua Shuford ROBINS, Marlborough, MA (US); J. Matthew CHAGNOT, Derry, NH (US); Eric Christopher BEISHLINE, Marlborough, MA (US); Gino Amaro PINTO, Milford, MA (US)

(21) Appl. No.: 15/545,888

(22) PCT Filed: Jan. 25, 2016
(86) PCT No.: PCT/US2016/014670

§ 371 Date: Jul. 24, 2017

Related U.S. Application Data
(60) Provisional application No. 62/107,361, filed on Jan. 24, 2015.

(51) Int. Cl. G01L 27/00; G01F 25/00; G01L 19/00; F15B 19/00

(52) U.S. Cl. CPC G01L 27/005; G01L 27/007; G01L 19/0015; G01F 25/0092; G01F 25/003; G01F 25/0038; F15B 19/002

(57) ABSTRACT

A system for controlling pressure associated with a volume may comprising a pump and piston/cylinder assembly, both in fluid communication with a volume of a closed fluid system. In addition, the system may comprise an actuator operatively connected to the actuator and pump to control fluid flow and pressurization or depressurization of the volume and/or fluid flow system. The pump is activated to generate a first pressure level of the closed fluid system and when this first pressure level is reached the actuator is activated to drive the piston/cylinder assembly to reach a pressure set point from the first pressure level. The system may be used as a calibrator or a pressure controller for pressure differentials, gauge pressure or absolute pressure.

This application claims benefit of the Jan. 24, 2015 filing date of application 62/107,361 which is incorporated by reference herein.

### FIELD OF THE INVENTION

Embodiments of the invention described herein relate to a system and method for generation of low and high pressures which are accurate and controllable. More specifically, the embodiments of the invention pertain to systems and method for use in calibrating devices, which will be referred to as devices under test (DUT) such as pressure transducers, pressure switches and pressure gauges as well as generation of accurate and precise pressures used in process control. These devices (DUT) are used for measurement of low pressures in applications such as HVAC (Heating, Ventilating and Air Conditioning) Systems.

### BACKGROUND OF THE INVENTION

A low differential pressure between two areas such as the pressure differential between two chambers or rooms is required for certain industrial and test facilities, including semi-conductor manufacturing facilities, hospital isolation rooms and spacecraft processing “clean” rooms. For example, a small or low pressure differential should be maintained between clean room areas and adjacent areas which do not have to be maintained under such clean conditions or for patient isolation areas such as infection control rooms or surgical suites.

In order to verify that the clean room is pressurized relative to the adjacent areas, pressure differential measurements must be made utilizing low differential pressure measuring transducers. A known method of pressure control may be found with the Setra Model 869 low pressure differential calibrator 10 as schematically illustrated in FIG. 1. The device 10 includes two extruded pressure control volumes 12, 13 and separate solenoid assemblies 16 mounted to a manifold 15 to isolate ambient pressure changes. A piston and cylinder assembly 14 is provided in fluid communication with the two volumes 12, 13 and is operatively connected to a micro-stepper motor 17 to drive the piston to pressurize or depressurize the volumes 12, 13 to create a detectable pressure differential. Two pre-calibrated reference pressure transducers 17, 18 are provided in fluid communication with the respective volumes to detect the pressure differential created in the two volumes 12, 13. The Setra Model 869 is portable so it can be taken into a pressurized room, for example, and linked to a pressure transducer used to monitor the pressure differential of the room and surrounding spaces to calibrate the pressure transducer or DUT.

Although these devices work well for their intended purpose, these prior art methods arguably have some shortcomings. In particular, the primary disadvantage of pressure control as incorporated in the Setra Model 869 is that because such devices have separate solenoid assemblies relative to a manifold and the two volumes, there exists a higher number of pressure connections, which increase the probability of system leaks and also increases cost and complexity.

Another disadvantage is that such devices are limited in pressure ranges because the piston and cylinder assembly can pressurize or depressurize in the range of −1 psi to +1 psi. In order to control pressure levels outside this range requires a separate air supply, which also results in increased cost and complexity and limits the capability of field use. Furthermore, a particular disadvantage of pressure control using air pumps is that the pumps produce an oscillatory pressure control that reduces accuracy. In addition, the accuracy of the pressure depends on the skill of the operator, which increases the possibility of error or variance.

### SUMMARY OF THE INVENTION

The inventors of the subject invention have discovered that incorporating a pump with the above described piston/cylinder assembly, a pressure control device may be used to pressurize or depressurize a volume at much greater pressure ranges, for example from about −13 psi to about +300 psi. In addition, by providing a programmable controller connected to the pump and an actuator, the pump may be used to achieve a pressure level to which point an actuator is activated to precisely control the pressure level to achieve a pressure set point. For example, the pump may be used to achieve a gauge pressure of +149.5 psi and the piston and cylinder assembly is then activated to achieve the additional 0.5 psi to achieve a gauge pressure of +150 psi. Such a device may be used to control pressure within a processing volume or chamber, or to control gauge pressure, differential pressure and/or absolute pressure of one or more volumes. In addition, the subject invention may be linked to a DUT to calibrate the DUT to monitor gauge, absolute or differential pressures.

An embodiment of a system for controlling a pressure level of a volume may comprise a closed fluid system including a cylinder and a piston disposed within the cylinder and the piston is moveable therein. The cylinder has at least one port, and the closed fluid system further comprises at least one enclosed volume in fluid communication with the cylinder to be pressurized or depressurized. An actuator is operatively connected to the piston to selectively move the piston within the cylinder. At least one pressure transducer is provided in fluid communication with the cylinder, and the at least one pressure transducer is configured to detect pressure levels within the closed fluid system. A pump is in fluid communication with the at least one pressure transducer and the at least one volume, and the pump is activated to achieve a first pressure level associated with a pressure set point within the closed fluid system.

A programmable controller is provided in signal communication with the at least one pressure transducer to receive signals indicative of the pressure level associated with the pressure, wherein the controller is in signal communication with the actuator and the controller is configured to activate the actuator to selectively move the piston within the cylinder to reach the pressure set point from the first pressure level.

In addition, the inventors have found that by integrating pressure chambers and a valve manifold into a single unit decreases the number of connections required to operate the system. To that end, a manifold block is provided that includes a first section in which a first and second chamber are disposed and a second section, integrally formed with the first section, and the second section includes a plurality of ports for fluid flow to and from the first and second chambers. In this manner, valves and other components of the pressure control system may be surface mounted to the manifold block to further integrate the system.

Also disclosed herein is a method for controlling a pressure level within a volume comprising providing a closed fluid system including a pump in fluid communication with a volume to be pressurized or depressurized to a pressure set point, and a piston and cylinder assembly is in fluid communication with the volume. The method also comprises the steps of activating the pump to pressurize or depressurize the volume to a first pressure level associated with the pressure set point; discontinuing fluid flow generated by the pump when the first pressure level is reached; and, activating the piston and cylinder assembly to generate a fluid flow to reach the pressure set point from the pressure level.

### DESCRIPTION OF THE DRAWINGS

FIG. 1 is a top planar view of a prior art pressure differential calibrator.

FIG. 2 is a schematic illustration of a pressure control system in accordance with aspects of the subject invention.

FIG. 3 is a schematic illustration of a pressure control system for controlling or calibrating a pressure differential.

FIG. 4 is a schematic illustration of a pressure control system for controlling or calibrating a gauge pressure.

FIG. 5 is a schematic illustration of a pressure control system for controlling or calibrating an absolute pressure.

FIG. 6 is an embodiment of a differential pressure calibration device.

FIG. 7 is a perspective view of a second embodiment of differential pressure calibration/control device.

FIG. 8 is a bottom perspective view of the second embodiment of FIG. 7.

FIG. 9 is a top planar view of a third embodiment of a differential pressure calibration device.

FIG. 10 is a sectional view of the third embodiment taken along line 9-9 of FIG. 9.

FIG. 11 is a block diagram for a controller or control system in accordance with aspects of the invention.

FIG. 12 is a flow chart providing steps of a method in accordance with aspects of the invention.

### DESCRIPTION OF THE INVENTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding the invention as disclosed and claimed herein, the preceding definitions are provided. It is further noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item.

The term “volume” as used herein may include an internal space in which a high or low pressure may be controlled. Accordingly, a volume may include an enclosed a processing volume, a volume within a pressure transducer, pressure gauge or pressure switch, or a volume within one or more chambers of the below described pressure transducers. The term “volume” may also include any reference pressure volume such as atmospheric pressure, gauge pressure, absolute pressure or a zero pressure volume. In addition, high pressure as used herein may include pressure levels greater than +1 psi, and low pressure are pressure levels less than −1 psi.

The term “pressurize” as used herein is intended to mean increasing a pressure within a closed fluid system or a volume of a closed fluid system above a reference pressure to a reference pressure set point associated the volume or closed fluid system. The term “depressurize” as used herein is intended to mean decreasing a pressure within a closed fluid system or a volume of a closed fluid system below a reference pressure to a reference pressure set point associated with the volume or closed fluid system.

The term “programmable controller” may include microcontrollers or micro-processors and any electrical components used to perform or facilitate any functions or steps of the invention disclosed herein.

With respect to FIG. 2, a pressure control device 20 is schematically illustrated including a pump 21 and piston/cylinder assembly 22. While embodiments of the invention may be illustrated described as pressure transducer calibrators, as explained above the invention is not so limited and may be used to control differential, gauge or absolute pressures in a volume or may be used to calibrate a DUT used to monitor differential, gauge or absolute pressures.

In this embodiment, a closed fluid system is provided including the pump 21 in fluid communication with a DUT 23 and a reference transducer 25. The DUT 23 is also in fluid communication with the piston/cylinder assembly 22. In this embodiment the DUT 23 is a differential pressure transducer that includes a low pressure side 23A, and a high pressure side 23B. A cylinder 28 of the piston/cylinder assembly 22 has opposing ports 26, 27 at respective ends of the cylinder 28. A piston 29 includes a piston head 30 mounted to a piston rod 32. The piston head 30 essentially divides the cylinder 28 into two chambers 28A, 28B wherein chamber 28A is a low pressure chamber in fluid communication with the low pressure side 23A of DUT 23 and the chamber 28B is a high pressure chamber in fluid communication with the high pressure side 23B of DUT 23. To that end, the reference pressure transducer 25 is in fluid communication with both chambers 28A, 28B of the cylinder 28. An end cap 48 seals an interior volume of the cylinder 28.

An actuator 31, such as a micro-stepper motor, is operatively connected to the piston rod 32 to move the piston head 30 back and forth in the cylinder 28 to control pressure levels in the chambers 28A, 28B. Accordingly, a coupling mechanism such as a lead screw may be provided to translate the rotational motion of the motor to a linear motion to drive the piston head 30 in the cylinder 28. The actuator 31 is not limited to a micro-stepper motors and may include other types of actuators like a servo motor, a linear actuator any other type of actuator that could be used to drive the piston head 30.

One or more valves, 34, 35, 36, preferably solenoid valves, are provided to control fluid flow from the pump 21 and piston/cylinder assembly 22 to the reference transducer 25 and DUT 23. While the embodiment shown in FIG. 2 includes three valves, the invention is not limited to any number of valves and the invention may include fewer or more than three valves. A programmable controller 33, preferably including micro-processor, is provided in signal communication with the reference transducer 25, pump 21, actuator 31 and valves 34 to control fluid flow in the closed fluid system.

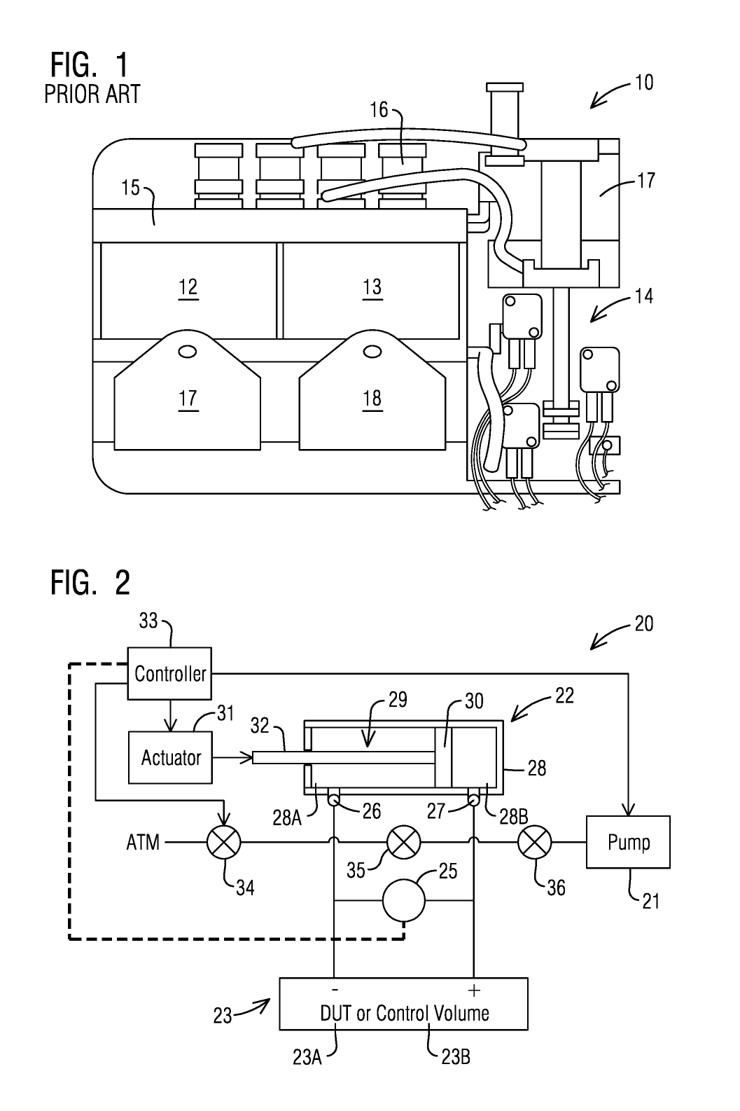

In an embodiment, if the desired control pressure is less than −1 psi or greater than +1 psi, the −1 psi and +1 psi pressures may be varied and used here only as an example, the controller 33 is programmed to activate the pump 21to pressurize or depressurize one or more volumes of the closed fluid system. With respect to FIG. 1, the one or more volumes may include the volumes of the reference transducer 25 and DUT 23. More specifically, the pump 21 is activated to generate a first pressure level in the one or more volumes. The controller 33 is in signal communication with the reference transducer 25 to receive signals indicative of a pressure level associated with a pressure detected by the reference transducer 25.

Once the first pressure level is achieved the controller 33 generates one or more signals to deactivate the pump 21 or close a valve 36 to discontinue fluid flow between the pump 21 and reference transducers 25 and DUT or control volume 23. In addition, the one or more signals from the controller 33 activates the actuator 31 to drive the piston 29 or piston head 30 within cylinder 28 to achieve a desired pressure set point for the closed fluid system. That is, once the pressure level within the closed fluid system is within a specified range of a desired pressure set point, fluid flow from the pump 21 is discontinued and the actuator 31 is activated so the piston/cylinder assembly 22 takes over the function of pressurization and/or depressurization to more precisely control pressure within the closed fluid system. For example, the piston/cylinder assembly 22 may be configured to control pressure levels within the range of −1 psi to +1 psi from the pressure set point.

When referring to “achieving” or “reaching” a pressure level, it is intended that these terms encompass falling within some acceptable range of a pressure level or pressure set point, is not necessarily limited to meeting an exact pressure reading.

An advantage of this particular configuration is the ability to produce a calibrator that enables precise, stable control over a wide range of pressures. Unlike previously known devices that typically enable a user to precisely control pressure at 0.0036 psi or below or devices that controlled higher pressures from 0 to 300 psi, the presently described system is able to precisely control pressure from very low to relatively high pressures by virtue of the ability to use the piston/cylinder to adjust the system volume when near the set point of a control pressure. The use of the double acting piston/cylinder assembly 22 in the high pressure control mode brings the advantage of a more precisely controlled pressure without the pulsing pressures of pumps or solenoid valve switching. It should be noted that the present new and novel system may be used in pressure calibrators, pressure controllers, process pressure controller and other types of calibrators and controllers.

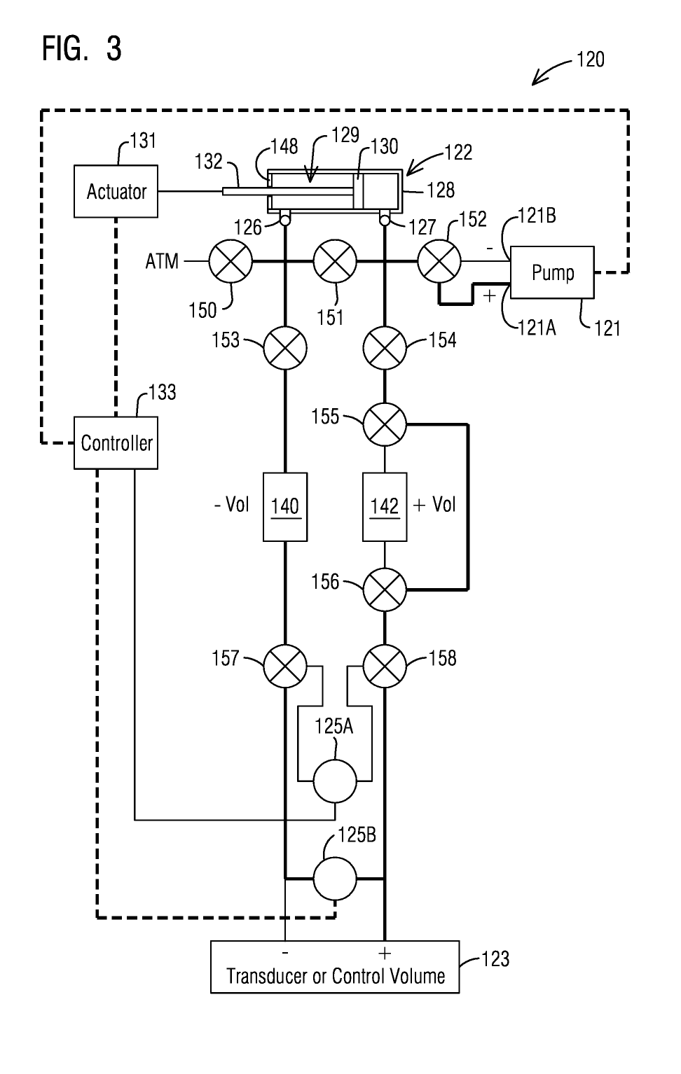

With respect to FIGS. 3, 4 and 5 embodiments of the invention are schematically illustrations for calibrating or generating a differential pressure, gauge pressure and absolute pressure, respectively. As in FIG. 1, the heavier or darker lines indicate fluid flow of the closed fluid flow system and the dashed lines indicate electrical signals between components of the system 20, 120. As shown in FIGS. 3, 4 and 5, and similar to the embodiment of FIG. 1, the system 120, includes a pump 121 in fluid communication with a DUT or control volume 123 and reference transducers 125A, 125B. While these embodiments include two reference pressure transducers 125A, 125B, the invention is not so limited and may include fewer or more reference pressure transducers.

In addition, a piston/cylinder assembly 122 is provided in fluid communication with the DUT or control volume 123 and reference transducers 125A, 125B. An actuator 131 is operatively connected to the piston/cylinder assembly 122 to drive the piston head 130within the cylinder 128. An end cap 148 is also provided to seal the cylinder 128. A controller 133 is provided in signal communication with the pump 121, actuator 131 and reference to transducers 125A, 125B to control fluid flow as described above. In addition, a series of valves 150, 151, 152, 153, 154, 155,156, 157, 158 are provided in signal communication with the controller 133 to control fluid flow from the pump 121 and piston/cylinder assembly 122 to the reference transducers 125A, 125B and DUT or control volume 123.

In the embodiments of FIGS. 3, 4 and 5, the system 120 includes a high pressure chamber 140 (or first chamber) and a low pressure chamber 142 (or second chamber); however, the invention is not limited to the use of any such chambers or the invention may only require a single chamber or more than two chambers. These chambers 140, 142 may be characterized as buffer volumes and may be used in calibrating or controlling pressures in an operating range of +/− 1 psi.

The embodiments of FIGS. 3, 4 and 5, and other embodiments may include nine valves, but depending on the configuration of the closed fluid system the system 120 embodiments may include fewer or more valves. Valve 150 is an atmospheric vent solenoid used to open chambers 140, 142 to atmospheric pressure. Valve 153 is a solenoid used to isolate the piston/cylinder assembly 122 from the rest of the low pressure volumes when the system needs to go into a “pump” cycle to reach pressures greater than that obtainable from a single stroke of the piston 129. Valve 151 is a cross vent solenoid used to connect chambers 140,142 in order to equalize the system pressure to produce zero differential pressure. Valve 154 is a pump solenoid valve used to isolate the piston/cylinder assembly 122 from the rest of the first and second chambers 140, 142 when the system 120 needs to go into a “pump” cycle to reach pressures greater than that obtainable from a single stroke of the piston.

Valves 155, 156 are three-way bypass solenoids used to “bypass” high pressure chamber 140 of the system 120. It is used when the desired pressures are less than −1 psi or greater than +1 psi. The elimination of the chamber 140 reduces the time to reach the desired pressure. Valves 157, 158 are reference solenoid used to select the pre-calibrated reference pressure transducers 125A or 125B that will have the highest signal to noise ratio for the selected pressure to be achieved. Finally, valve 152 is a high pressure/high vacuum select solenoid valve used to route either vacuum or high pressure side of the high pressure/vacuum pump item 121.

A pump that may be used with embodiments is a rotary vane mini-pump that includes a high pressure port and a vacuum pressure port and is preferably able to generate pressure levels from about −13.5 psi to about 300 psi. Such a pump is preferably an electrically driven pump; however other pumps such as pneumatic pumps, manually actuated pumps etc. may be used with the system 120.

Again in reference to FIG. 3, the system 120 is configured for calibration or control of a differential pressure. Accordingly both the high pressure chamber 140 and low pressure chamber 142 are in fluid communication with one or both of the reference pressure transducers 125A, 125 and the DUT or control volume 123. In operation, the controller 133 signals to activate the pump 121 to generate or achieve a pressure level that is within some predetermined range of a pressure set point. The pump 121 preferably has two ports including a high pressure port 121A and vacuum pressure port 121B. In this example, the valve 152 is controlled to select high pressure flow for fluid communication between the pump 121 and first chamber 140 and valves 150 and 151 are closed to isolate the second chamber 142 from the first chamber140 and atmosphere. As indicated above, the pump 121 is used when calibrating or controller pressures that exceed +1 psi, or are less than −1 psi; otherwise the piston/cylinder assembly 122 and actuator 131 may be used to achieve the pressure within this low pressure range.

During this “pump cycle” one or both reference pressure transducers 125A, 125B generate signals indicative of a pressure in the first and second chambers 140, 142 or within the DUT or control volume 123. When the pressure approaches, reaches or is within some predetermined range of a set point pressure, fluid flow from the pump 121 is discontinued by the controller 133 deactivating the pump 121 or closing valve 158. The controller 133 also activates the actuator 31 to drive the piston 129 of the piston/cylinder assembly 122 to further adjust the pressure level within a range of about −1 psi to about +1 psi.

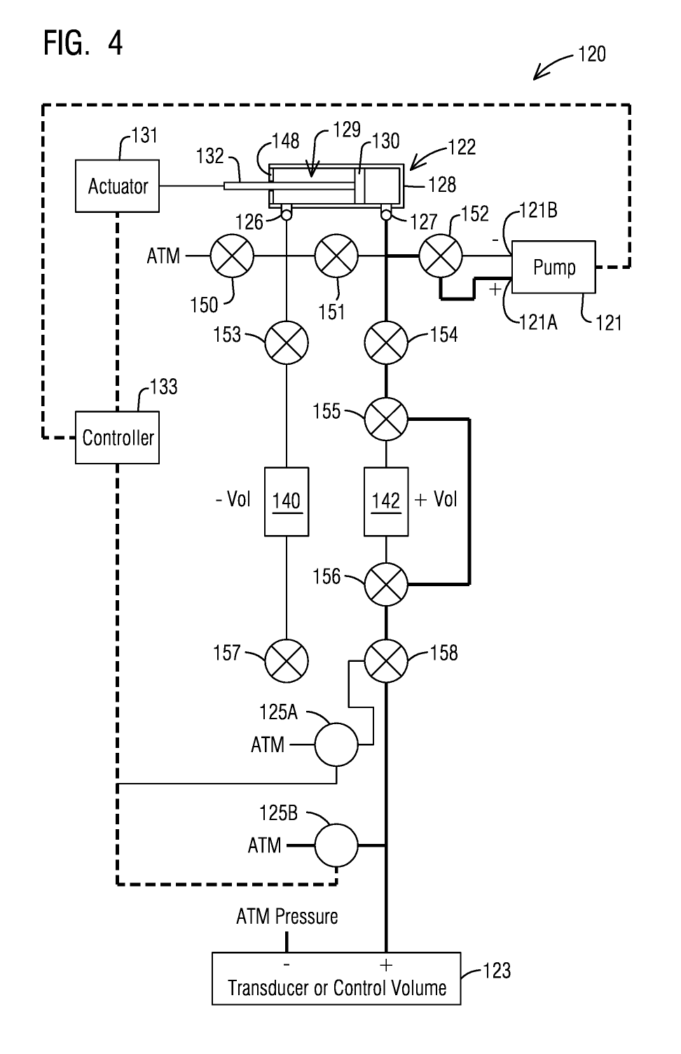

In reference to FIG. 4, the system 120 is used to calibrate or control gauge pressure. In gauge pressure mode the DUT and Ref units are open to atmosphere on their reference sides, valve 151 is closed, and valves 150, 153 and 157 are opened. Accordingly, valves 155, 156 are activated by the controller 133 to bypass the first chamber 140, so the pump 121 is in fluid communication with one or both reference pressure transducers 125A, 125B and the DUT or control volume 123. In addition, the second chamber 142 and low pressure side of the DUT or control volume 123 are opened to atmosphere to calibrate or control gauge pressure, which is the pressure relative to atmospheric pressure.

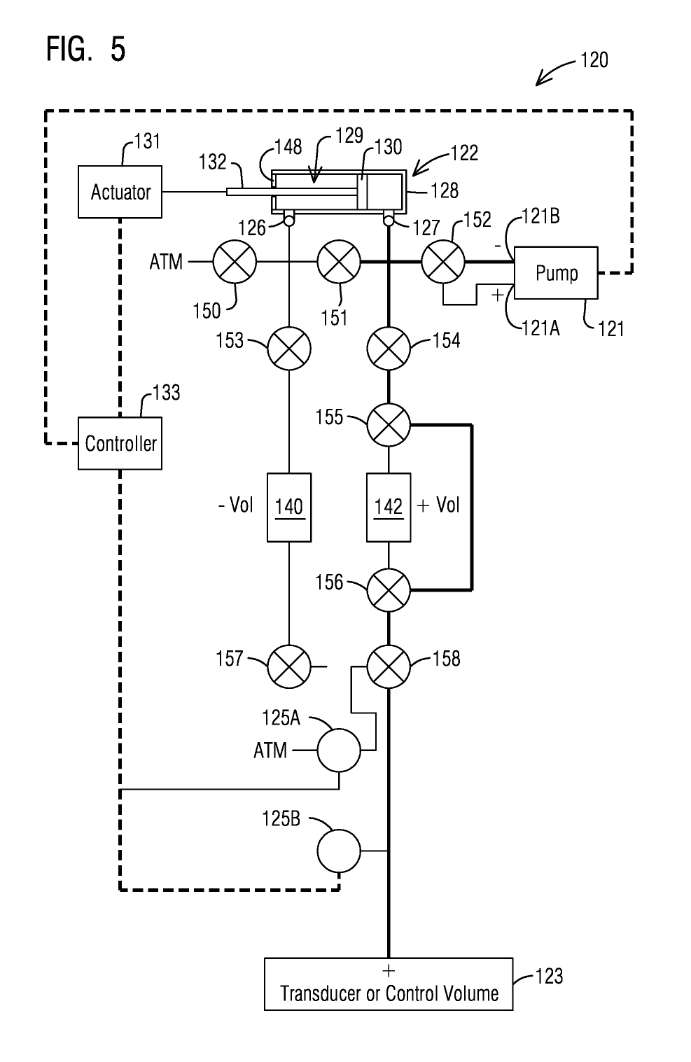

In reference to FIG. 5, the system 120 is used to calibrate or control absolute pressure, which is the measure of pressure relative to a vacuum. Accordingly, valves 155, 156 are activated by the controller 133 to bypass the first chamber 140, so the pump 121 is in fluid communication with one or both reference pressure transducers 125A, 125B and the positive pressure side of the DUT or control volume 123. In addition, the second chamber 142, and low pressure side of the DUT or control volume 123 are either sealed or open relative to atmosphere, and the reference pressure transducers 125A, 125B calibrate or control absolute pressure within the DUT or control volume 123.

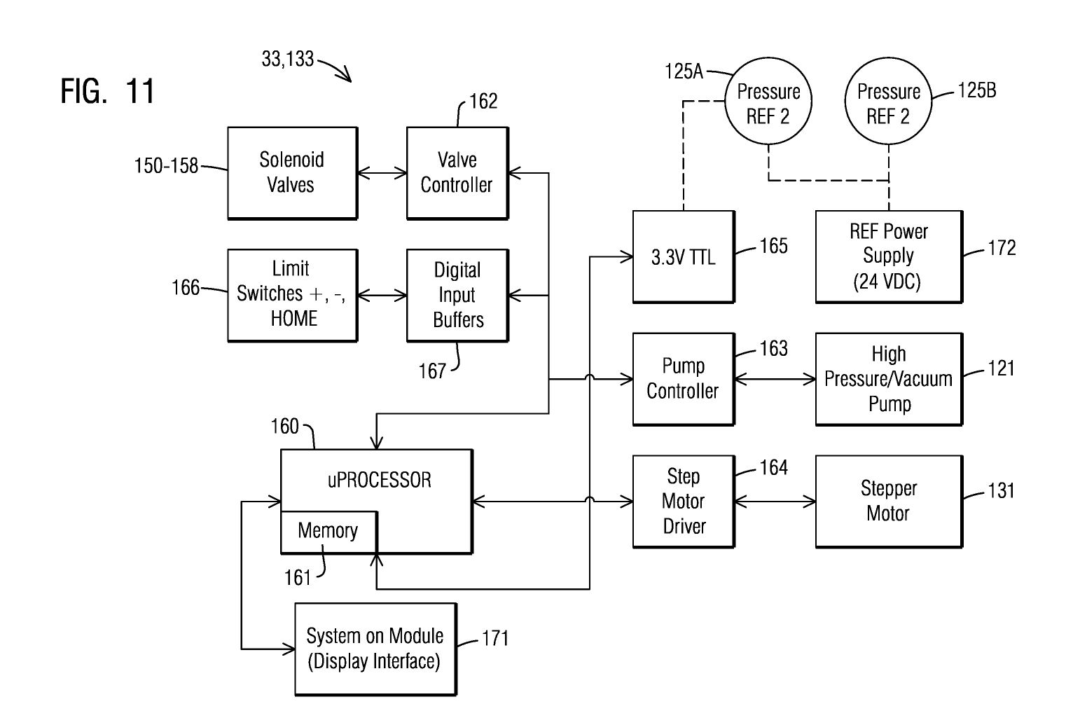

An example of a controller 33, 133 that may be used in the present invention is shown in FIG. 11 and includes a microprocessor 160 with a memory device 161. The microprocessor 160 may be any 8 bit to 32 bit processor that is programmable to perform the functions associated with aspects of the invention. Additional components of the controller 133 may include a valve controller 162 for operation of the solenoid valves, a pump controller 163 for operation of the pump and a motor driver 164 for operation of the actuator 131, all of which are in signal communication with the microprocessor 160. In addition, the controller 33, 133 may include 3.3 V transistor-transistor logic 165 for signal communication with the microprocessor 60 and the reference pressure transducers 125A, 125B. A power supply 172 is also provided for powering the reference pressure transducers 125A, 125B.

As further shown in FIG. 11, a controller interface 171may be provided including input devices such as a keyboard and/or a touch screen input device. In addition, the controller 133 may be configured to output data relative to detected pressure levels. The display may also show the electrical output of the DUT, the accuracy of the DUT, the applied control pressure, the system leak rate, system setup parameters, a database of DUTs, pressure gauge and pressure switch settings, etc.

In an embodiment, the controller 133 may include or is in signal communication with limit switches 166 to detect the position of the piston 129 relative to the cylinder 128. Accordingly, digital input buffers 167 are provided for communication between the limit switches 166 and the microprocessor 160. The limit switches may be light emitting diodes (LEDs) for detecting the position piston 129 or piston head 130. For example, the system 120 or controller 133 may include three limit switches, two of which are associated with opposite ends of a piston stroke and one of which is associated with a center position of a piston stroke.

The controller 33, 133 including its electrical components is preferable fabricated on a stand-alone printed circuit board that is mounted relative to the flow control components such as the pump 21, 121, actuator 31, 131 and valves 34, 35, 36, and 150-158 for electrical connection thereto.

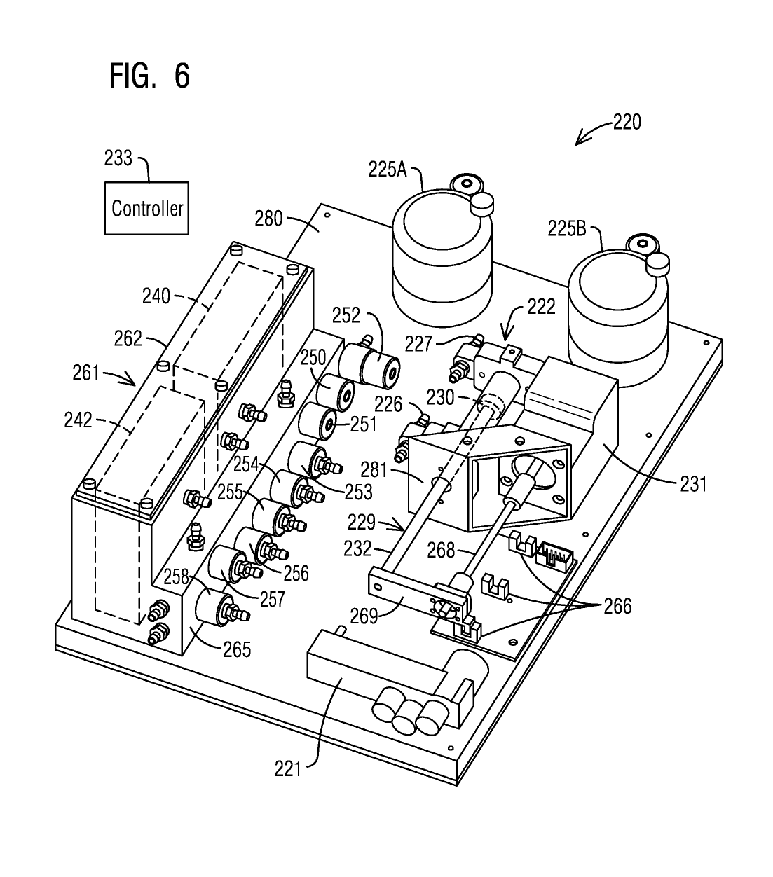

Another aspect of the invention includes the integration of components of the system 20, 120, namely the integration of a manifold and the volume buffer chambers (first and second chambers). In reference to each of the embodiments shown in FIGS. 6-10, one skilled in the art will appreciate that fluid lines are necessary to maintain fluid flow through the closed fluid system; however, fluid lines are not illustrated only for purposes of better identifying components of the systems described herein. With respect to FIG. 6, an embodiment of pressure calibration and control device 220 is shown including a manifold block 261 having a first section 262 in which a first chamber 240 and second chamber 242 (also referred to as volume buffers) are formed. The manifold block 261 also includes a second section 265 integrally formed with the first section 262 and having a plurality of ports (not shown) and/channels formed therein for providing fluid communication between the first and second chambers 240, 242 and other components of the system 220.

A plurality of valves 250-258 are mounted to an external surface of the second section 265 in fluid communication with the ports and first and second chambers 240, 242. In this embodiment, the manifold block 261 and other components are mounted on a board 80. As described above, the system 220 includes a pump 221 in fluid communication with first and second chambers 240, 242, one or both of the reference transducers 225A, 225B and the DUT or control volume (not shown in FIG. 6).

With respect to the actuator 231, which may be a micro-stepper motor, a linear coupling is provided to convert the rotational motion of the motor to a linear motion. As shown, a lead screw 268 is connected to one end to the actuator 231 and at another end to a drive arm 269, which is connected to the piston rod 232 of the piston/cylinder assembly 222. A bracket 281 is mounted to the board 280 to support the linear coupling components 268, 269 and the piston/cylinder assembly 222 relative to one another.

The limit switches 266 are mounted to the board 280 relative to the piston/cylinder assembly 222 to detect the position of the piston head 230 in the cylinder 228. In addition, the reference pressure transducers 225A, 225B are also mounted to the board.

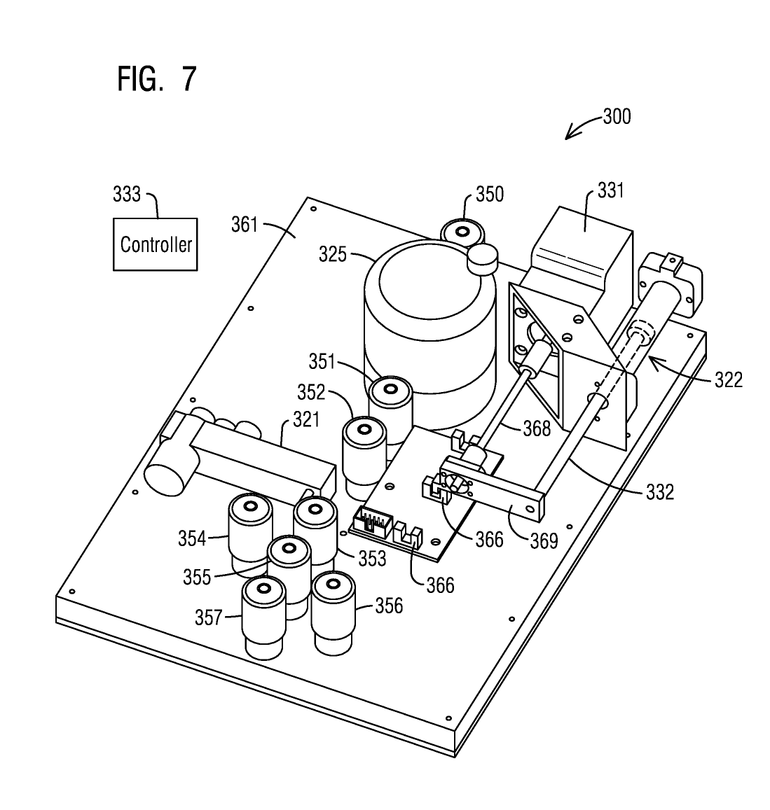

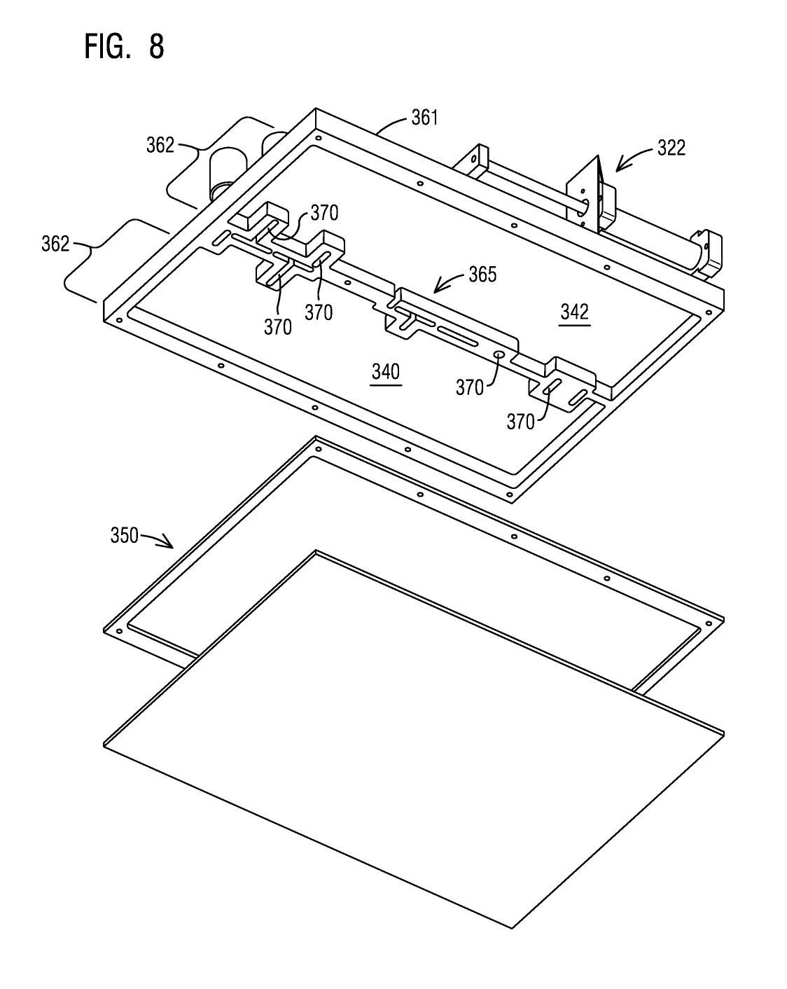

A second embodiment of a pressure calibration and control system 300 is shown in FIGS. 7 and 8, wherein the manifold block 361 takes the form of a planar block member with all components external to the first and second chambers 340, 342 and plurality of ports 370 (FIG. 8) are mounted to an external surface of the manifold block 361. Namely, the valves 350-357, actuator 331, piston cylinder assembly 322, pump 321 and reference pressure transducer 325 are all mounted to an external top surface 330 of the manifold block 361. Again, a controller 333 is provided on a stand-alone PCBA and electrical connections are provided as necessary to drive, control or communicate with components such as the pump 321, the actuator 331or the reference pressure transducer 325.

With respect to FIG. 8, a gasket and cover plate assembly 350 is shown removed revealing the first and second chambers 340, 342, which define the first section 362 of the manifold block 361which is integrally formed with a second section 365. A series of ports and channels 370 are provided in the second section 365 in fluid communication with the first and second chambers 340, 342 the valves 350, pump 321 and reference pressure transducer 325.

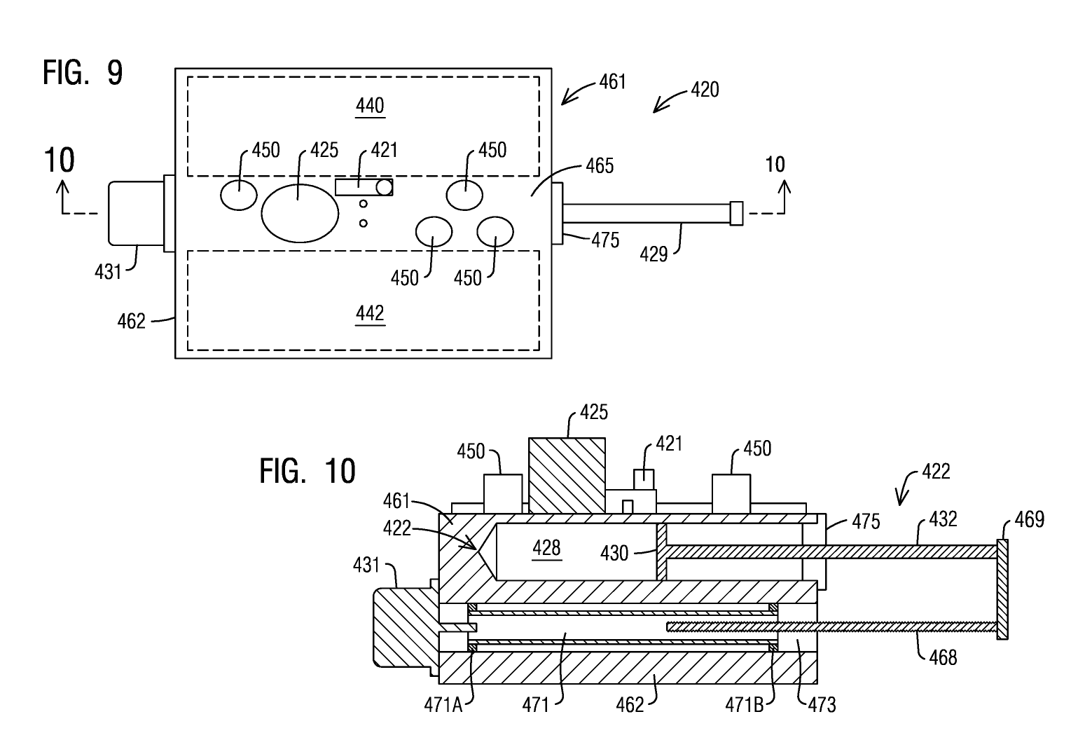

A third embodiment of the pressure calibration and control system 420 is shown in FIGS. 9 and 10, and includes further integration of components by internally mounting or fabricating components of the piston/cylinder assembly 422 and/or the linear coupling components. As shown, from a top view in FIG. 9, the first and second chambers 440, 442 form the first section 462 of the manifold block 461. The second section 465 of the manifold block 461 is disposed above and between, or entirely between, or below and between the first and second chambers 440, 442. Although, not specifically shown, ports are formed in the second section for fluid flow in and out of the chambers 440, 442.

In reference to FIG. 10, the cylinder 428 of the piston/cylinder assembly 422 is formed in the second section 465 of the manifold block 461 and is sealed at one end by a bushing 475, and the piston 429 is moveable linearly within the cylinder 428. As further shown, the actuator 431 is mounted at one end of the manifold block 461 and is operatively connected to one end of a rotating cylindrical coupler 471, and a lead screw 468 is provide in threaded engagement at the other end of the cylindrical coupler 471. As shown, the cylindrical coupler 471 and at least portion of the lead screw 468 are disposed within conduit 473 formed in the second section 465 of the manifold block 461. The cylindrical coupler 471 has disc or cylindrical bearings 471A, 471B at each end to allow for rotation within the conduit 473. Similar to the above described linear coupling, a drive arm 469 is connected to the lead screw 468 and piston rod 429 to linearly move the piston head 430 within the cylinder to control or adjust pressure as needed. External components such as the pump 421, valves 450, and reference transducer 425 are mounted to an external surface of the second section 465.

For any of the above described embodiments shown in FIGS. 6-10, the manifold block may be composed of material such as a metal or metal alloy, such as aluminum or an aluminum alloy that is machined to include or define the first and second sections and components thereof, namely any chambers or ports. Alternatively, the manifold may fabricated from a plastic material using known molding techniques. Such a plastic material may be a polypropylene, polyvinyl chloride, polyethylene plastics or other plastic materials. In addition, the controller 33, 133 may be used in connection with any embodiments disclosed here, and is preferably fabricated with electrical components on a stand-alone PCB and mounted relative to the manifold block 261, 361 and 461 and any fluid flow components for the system.

In addition, with respect each of the embodiments disclosed in FIGS. 6-10, the valves, ports and channel, and any fluid lines may arranged according to the schematics of FIGS. 3-5, which represent an example of how fluid flow may be controlled in accordance with aspects of the invention.

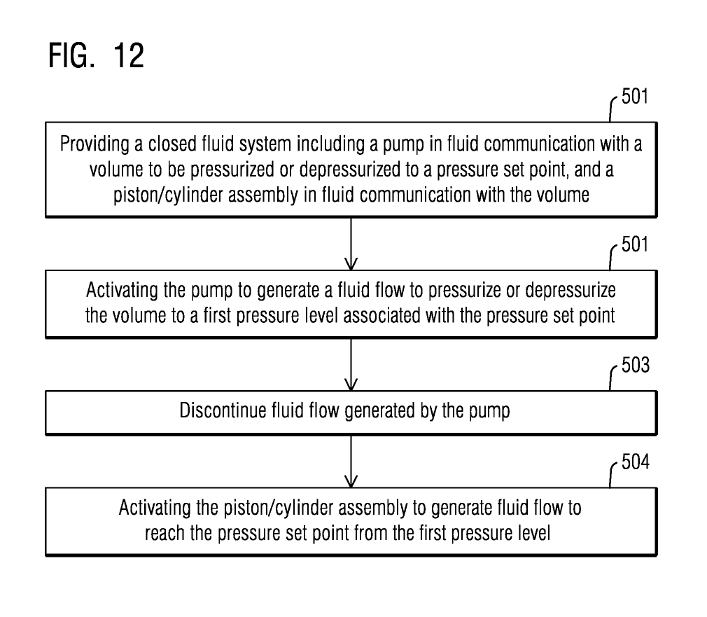

With respect to FIG. 12 a flow chart is shown including steps to a method for calibrating or controlling pressure for volume to be pressurized or depressurized. In a first step 501 a closed fluid system is provided including a pump in fluid communication with a volume to be pressurized or depressurized to a pressure set point, and a piston/cylinder assembly in fluid communication with the volume. In a second step 502, the pump is activated to create fluid flow to pressurize or depressurize the volume to a first pressure level associated with the pressure set point. In a third step 503, the fluid flow generated by the pump is discontinued. In a fourth step 504, the piston/cylinder assembly is activated to generate a fluid flow to reach the pressure set point from the first pressure level.

The method may also include the step of monitoring pressure levels within closed fluid system to detect the first pressure level and the pressure set point. To that end a first reference pressure transducer and a second reference pressure transducer may be provided for monitoring pressure levels of the closed fluid system. At least with respect to pressure differential, the at least one volume may include a first volume and a second volume and the method may comprise monitoring a pressure differential between the first volume and a second volume associated with the closed fluid system. In addition, or alternatively, gauge pressure and absolute pressure of the closed fluid system may be monitored.

While the preferred embodiments of the present invention have been shown and described herein, it will be obvious that such embodiments are provided by way of example only. Numerous variations, changes and substitutions will occur to those of skill in the art without departing from the invention herein. Non-limiting examples include a component that is described above as being attached to one part of the apparatus may alternatively be attached to a different part of the apparatus in other embodiments. Parts described as being indirectly connected may be connected directly to each other, and vice versa. Component parts may be assembled from individual pieces or may be integrally formed as a single unit. Alternative types of connectors and alternative materials may be used. The apparatus may be used with other types of power tools. Accordingly, it is intended that the invention be limited only by the spirit and scope of the appended claims.

What we claim is:

1. A system for controlling a pressure level of a volume, comprising:
a closed fluid system including a cylinder and a piston disposed within the cylinder and the piston is moveable therein, wherein the cylinder has at least one port, and the closed fluid system further comprising at least one enclosed volume in fluid communication with the cylinder to be pressurized or depressurized;
an actuator operatively connected to the piston to selectively move the piston within the cylinder;
at least one reference pressure transducer in fluid communication with the cylinder, and the at least one reference pressure transducer is configured to detect pressure levels within the closed fluid system;
a pump in fluid communication with the at least one reference pressure transducer and the at least one volume, and the pump is activated to pressurize or depressurize the closed fluid system to a first pressure level associated with a pressure set point for the closed fluid system; and
a programmable controller in signal communication with the at least one reference pressure transducer to receive signals indicative of one or more pressure levels within the closed fluid system, wherein the controller is in signal communication with the actuator, and the controller is configured to activate the actuator to selectively move the piston within the cylinder to reach the pressure set point from the first pressure level.

2. The system of claim 1 wherein the at least one the at least one reference pressure transducer is configured to detect a pressure differential associated with the at least one volume relative to some other reference pressure.

3. The system of claim 1 wherein the at least one volume comprises a first chamber and a second chamber, both of which are in fluid communication with the at least one reference pressure transducer.

4. The system of claim 3 wherein the at least one reference pressure transducer is configured to detect a pressure differential associated with the closed fluid system, and the at least one volume further comprises a second pressure transducer that is configured to detect the pressure differential associated with the closed fluid system and the reference pressure transducer is used to calibrate the second pressure transducer.

5. The system of claim 3 further comprising a manifold block having a first section in which the first chamber and the second chamber are disposed and a second section integrally formed with the first section, and the second section includes a plurality of ports to control fluid flow in and out of the first chamber and second chamber.

6. The system of claim 5 further comprising a plurality of valves mounted to an external surface of the second section of the manifold block and each valve is associated with a port in the second section.

7. The system of claim 3 further comprising a plurality of fluid lines and a plurality of valves to control fluid flow in the closed fluid system and one or more of the valves and the fluid lines are controlled to bypass the first chamber and vent the second chamber to atmosphere to calibrate or control gauge pressure.

8. The system of claim 3 further comprising a plurality of fluid lines and a plurality of valves to control fluid flow in the closed fluid system and one or more of the valves and the fluid lines are controlled to bypass the first chamber and seal the second chamber relative to atmosphere to calibrate or control absolute pressure.

9. The system of claim 1 wherein the controller is in signal communication with the pump and the actuator and the controller is configured to activate the pump to achieve the first pressure level and then deactivate the pump when the first pressure level is reached and then activate the actuator to selectively move the piston within the cylinder to achieve the pressure set point within the closed fluid system.

10. The system of claim 1 further comprising a plurality of valves in signal communication with the controller, and at least one valve is associated with fluid flow to or from the pump and the controller is configured generate a signal to close the valve when the first pressure level is reached.

11. The system of claim 1 wherein the at least one volume comprises a first chamber and a second chamber each in fluid communication with the pump and the at least one reference pressure transducer, wherein the closed fluid system is linked with a differential pressure transducer to be calibrated

12. The system of claim 11 the at least one reference pressure transducer comprises a first reference pressure transducer and a second reference pressure transducer both of which are in fluid communication with the first chamber and second chamber to detect a pressure differential associated with the first chamber and second chamber.

13. The system of claim 1 wherein the actuator is a stepper motor operatively connected to the piston via a linear coupling to translate a rotational motion of the stepper motor to a linear motion to selectively move the piston within the cylinder.

14. The system of claim 1 wherein the pump is an electrical pump.

15. The system of claim 1 wherein the pump is a pneumatic pump.

16. The system of claim 1 wherein the pump is a manually actuated pump.

17. A system for controlling a pressure level of a volume, comprising:
a closed fluid system including a manifold block having a first section including a first chamber and a second chamber, and the manifold block further having a second section integrally formed with the first section and the second section includes a plurality of ports for fluid flow in and out of the first chamber and the second chamber, and the first chamber and second chamber are in fluid communication with a volume to be pressurized or depressurized;
a piston and cylinder assembly in fluid communication with the first chamber and the second chamber;
an actuator operatively connected to the piston to selectively move the piston within the cylinder to control respective pressure levels within the first chamber and the second chamber;
at least one reference pressure transducer in fluid communication with the first chamber and second chamber, and the at least one reference pressure transducer is configured to detect respective pressure levels within the first chamber, the second chamber and the volume;
a programmable controller in signal communication with the at least one reference pressure transducer to receive signals associated a pressure level detected by the at least one reference pressure transducer, wherein the controller is in signal communication with the actuator, and the controller is configured to activate the actuator to selectively move the piston within the cylinder to a pressure set point from the pressure level within the closed fluid system.

18. The system of claim 17 further comprising a plurality of valves mounted to one or more external surfaces of the manifold block and each valve is operatively connected to a corresponding port formed in the second section of the manifold block.

19. The system of claim 18 further comprising a pump in fluid communication with one or both of the first chamber and second chamber, and the controller is in signal communication to activate the pump to generate a pressure level associated with the pressure set point for the closed fluid system, and the controller is configured to generate one or more signals to discontinue fluid flow generated by the pump when the pressure level is reached and then generate one or more signals to activate the actuator wherein the piston is actuated with the cylinder to achieve the pressure set point of the closed fluid system.

20. The system of claim 17 wherein the cylinder is integrally formed within the first section or second section of the manifold block.

21. The system of claim 20 wherein the actuator is mounted to an external surface of the manifold block and a conduit is formed within the first section or second section of the manifold block and at least a portion of a coupling is disposed within the conduit, and the coupling operatively connects the piston to the actuator.

22. A method for controlling a pressure level within a volume, comprising:
providing a closed fluid system including a pump in fluid communication with a volume to be pressurized or depressurized to a pressure set point, and a piston and cylinder assembly is in fluid communication with the volume;
activating the pump to pressurize or depressurize the volume to a first pressure level associated with the pressure set point;
discontinuing fluid flow generated by the pump when the first pressure level is reached; and,
activating the piston and cylinder assembly to generate a fluid flow to reach the pressure set point from the pressure level.

23. The method of claim 22 further comprising monitoring pressure levels within closed fluid system to detect the first pressure level and the pressure set point.

24. The method of claim 23 further comprising providing a reference pressure transducer and a pressure transducer to be tested and for monitoring pressure levels of the closed fluid system.

25. The method of claim 24 further comprising calibrating the pressure transducer to be tested relative to the reference pressure transducer.

26. The method of claim 22 wherein the volume is a first volume and the method further comprises monitoring a pressure differential between the first volume and a second volume associated with the closed fluid system.

27. The method of claim 22 further comprising monitoring a gauge pressure of the closed fluid system.

28. The method of claim 22 further comprising monitoring an absolute pressure of the closed fluid system.
